(19) United States
(12) Patent Application Publication
(10) Pub. No.: US 2001/0056309 A1
(43) Pub. Date: Dec. 27, 2001

(54) Three-dimensional replica creation process

(76) Inventors: Prabhat Jain, New Orleans, LA (US); Joel Lema, Kenner, LA (US)

Correspondence Address: JOEL LEMA, 4219 BARONNE, NEW ORLEANS, LA, 70115, US

(21) Appl. No.: 09/879,601

(22) Filed: Jun. 12, 2001

Related U.S. Application Data
(60) Provisional application No. 60/213,142, filed on Jun. 22, 2000.

(51) Int. Cl. G06F 19/00

(52) U.S. Cl. 700/98

(57) ABSTRACT

The electronic digitizers at the scanning center produce a raw file. The raw file (comprising the three-dimensional information) is further processed and an enhanced output file is produced. The enhanced file is sent to a fulfillment center where the actual conversion into a replica physical object takes place. To allow for faster turnaround times, electronic means are used to send the file to the fulfillment center. The replica is enhanced by additional hand carving or sculpting. The physical replica is further enhanced by mounting the replica on structures that enhance the artistic presentation of the replica. The physical replica can be used as a pattern in casting, investment casting, and casting for mass production. Thus, by coordinating disparate technologies (e.g. electronic three-dimensional digitizers, rapid prototyping machines, casting, investment casting, casting for mass production) and by evolving suitable processes we specifically create a system to produce replica three-dimensional physical objects from captured three-dimensional image data of objects.

### REFERENCE TO RELATED APPLICATIONS

This application claims the benefit of U.S. provisional application No. 60/213142, filed on Jun. 22, 2000, entitled “Three Dimensional Replica Creation Process.”

### BACKGROUND

The invention relates to processes for capturing and customizing the three-dimensional information of a subject with the specific intent of creating three-dimensional replicas of the subject. Currently, processes exist for capturing images in three dimensions and similarly processes exist to convert three-dimensional engineering design data into physical objects. However, a single streamlined process combining the capturing of the three-dimensional data and with the specific intent of producing physical objects does not exist. In particular, there are no simple, complete ways of creating three-dimensional replicas of subjects. Thus, there is a need for a single streamlined process, whereby an individual or other entity, can capture an image in three-dimensions utilizing suitable materials to convert the image into a replica physical object with an artistic presentation.

### SUMMARY

A process having features of the invention satisfies this need. According to the process, the subject is scanned at a scanning center. The electronic digitizers at the scanning center produce a raw file. The raw file (comprising the three-dimensional information) is further processed and an enhanced output file is produced. The enhanced file is sent to a fulfillment center where the actual conversion into a replica physical object takes place. To allow for faster turnaround times, electronic means are used to send the file to the fulfillment center. The replica is enhanced by additional hand carving or sculpting. The physical replica is further enhanced by mounting the replica on structures that enhance the artistic presentation of the replica. The physical replica can be used as a pattern in casting, investment casting, and casting for mass production. Thus, by coordinating disparate technologies (e.g. electronic three-dimensional digitizers, rapid prototyping machines, casting, investment casting, casting for mass production) and by evolving suitable processes we specifically will create a system to produce replica three-dimensional physical objects from captured three-dimensional image data of objects.

### DRAWINGS

FIG. 1 is a flowchart of a process having features of the invention.

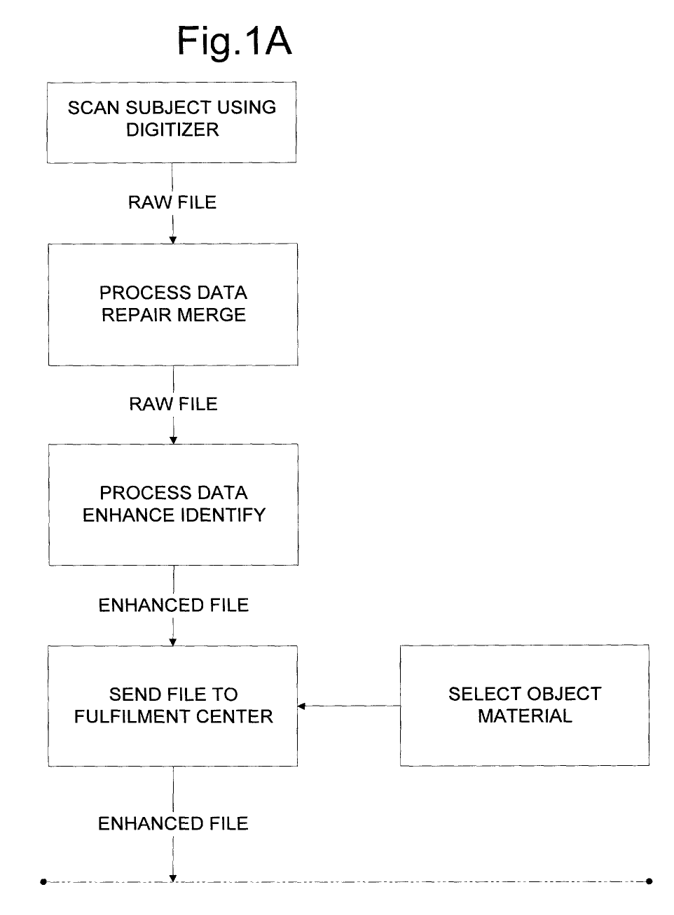

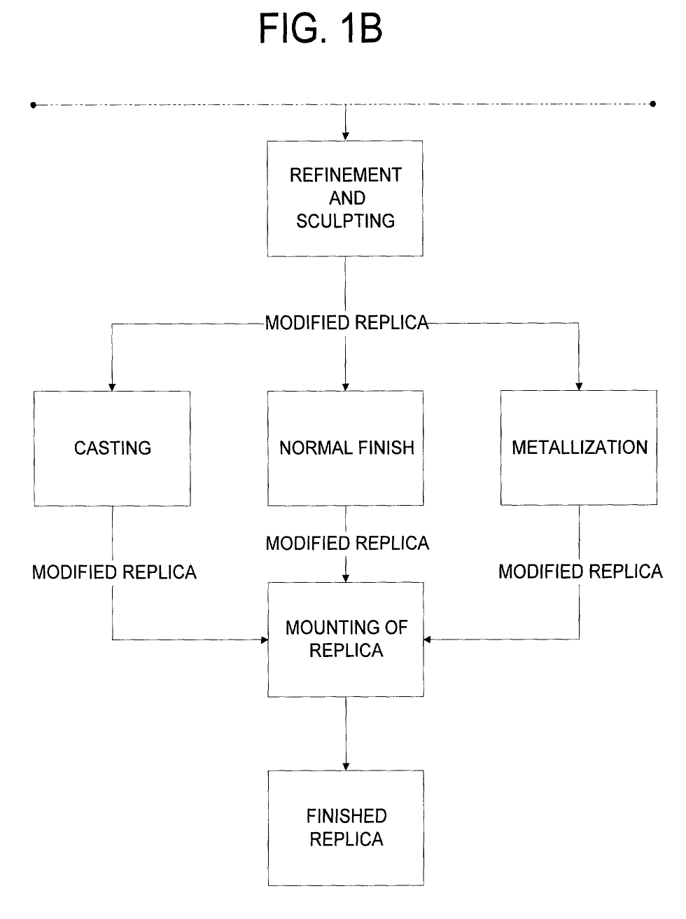

### DETAILED DESCRIPTION

Digitizing the three-dimensional image of a subject starts the process. The subject can be an animate object (such as a person, animal, plant, etc.) or an inanimate object (such as a sculpture, structure, etc). The digitizer is an electronic device that captures the three-dimensional image in a computer readable format suitable for computer processing. The scanning can take place at scanning center where the digitizer may be housed. The scanning center can use one digitizer to sequentially scan the subject in multiple passes or use multiple digitizers to scan the subject in one pass. Once the digitizer completes the scanning process a raw file is generated and is ready to be processed.

The first level of processing is used to convert the raw file into a form suitable for the next level of processing. Any damage or distortion introduced by the digitizer is processed and repaired. If multiple scans were taken of the object, the images are combined into one. The distortions are rectified preferably using computer programs and other mathematical processing. The raw file can also be repaired preferably using computer programs and other mathematical processing.

The raw file is processed again to enhance or add customizations to the original object. The customizations can preferably comprise the merging of other files (to combine different objects), computer generated files (such as support structures), and other artistic enhancements.

The raw file is enhanced again to add identification indicia. The indicia are preferably specified in separate files that are added to the raw file. The identification markings and features can preferably comprise text and other geometric forms.

The enhanced file is processed again into a form suitable for use by manufacturing machines (preferably rapid prototyping machines or similar apparatus). The enhanced file is scaled and oriented in such a way as to maximize unit capacity in the machine and to minimize build time in the machine.

Once the enhanced file is deemed ready for manufacture, the enhanced file is sent to a fulfillment center where the replica physical object is manufactured. The enhanced file is preferably sent through electronic means (such as the internet, or through a direct connection) and is done as fast as possible. The fulfillment center can be either a local center or a remote site. The fulfillment center can aggregate the objects from multiple scanning centers and in so doing generate economies of scale that apply to reducing the cost and time of manufacture of each object. The fulfillment center preferably has one or more rapid prototyping machines dedicated to the task of producing the objects generated by the scanning centers.

The material comprising the replica physical object can be selected depending on the requirements of the final product or other artistic criteria. The materials can be chosen to allow for hand carving and sculpting and in so doing enhance the artistic form of the object. Some examples of materials are: plaster, starch, gypsum, wax, and cellulose.

The replica physical objects are then turned over to an artistic reworking process. The replica physical object can be further sculpted and refined by a sculptor. The added sculpting and refining may preferably comprise of highlighting of small details (such as features on human face), adding details to the replica physical object (such as adding hair to a human head), and adding features to enhance the artistic form of the replica physical object (such as adding neck and shoulders to a human head).

The replica physical objects are then subjected to a refinishing process. The refinishing can preferably comprise of waxing, metallization, painting, casting, investment casting, and casting for mass production.

Preferably, after refinishing, the object is mounted on an external structure. These structures can consist of bases, pedestals, blocks, reliefs, geometric forms, and other sculptures. Although the invention has been described in detail with reference to a preferred version, other versions are possible. Therefore, the spirit and scope of the claims are not limited to the description of the preferred version.

What is claimed is:

1. A process for creating a three-dimensional physical replica of a subject, comprising:
a) digitizing an image of a subject at a scanning center using three-dimensional image digitizers to produce a raw file;
b) processing the image at the scanning center to produce an enhanced output file;
c) electronically transmitting the enhanced output file to a fulfillment center;
d) manufacturing a three-dimensional physical replica of the subject from the enhanced output file;

2. The process of claim 1, wherein in (b), the raw file is processed to remove distortion and repair any problems in the file.

3. The process of claim 1, wherein in (b), the raw file is processed to enhance the artistic value of the raw file.

4. The process of claim 1, wherein in (b), the raw file is processed with the addition of identification indicia.

5. The process of claim 1, wherein in (b), the raw file is processed to combine the raw file with other files to generate a new raw file.

6. The process of claim 1, wherein in (b), the raw file is processed into a form suitable for the manufacturing machines.

7. The process of claim 1, further comprising:
using a sculptor to further refine the replica physical object for artistic enhancement.

8. The process of claim 1, further comprising:
specifying an object material out of which the replica is produced

9. The process of claim 1, further comprising:
the deposition of a metal surface on the replica.

10. The process of claim 1, further comprising:
using the physical replicas as patterns for casting.

11. The process of claim 1, further comprising:
mass producing the physical replicas

12. The process of claim 1, further comprising:
mounting the physical replica on structures for artistic presentation.
